(19) United States
(12) Patent Application Publication
(10) Pub. No.: US 2022/0107860 A1
(43) Pub. Date: Apr. 7, 2022

(54) DEVICE MANAGEMENT SYSTEM, DEVICE MANAGEMENT METHOD, AND RECORDING MEDIUM

(71) Applicant: Shogo AIZAWA, Kanagawa (JP)

(72) Inventor: Shogo AIZAWA, Kanagawa (JP)

(73) Assignee: Ricoh Company, Ltd., Tokyo (JP)

(21) Appl. No.: 17/448,560

(22) Filed: Sep. 23, 2021

(30) Foreign Application Priority Data
Oct. 1, 2020 (JP) 2020-166997

(51) Int. Cl. G06F 11/07; G06F 11/32; G06Q 30/00

(52) U.S. Cl. CPC G06F 11/079; G06Q 30/016; G06F 11/0784; G06F 11/327

(57) ABSTRACT

A device management system includes a memory, and a processor coupled to the memory and configured to collect device information of an electronic device, determine whether a first error that is an error not resolvable by a user has occurred in the electronic device based on the device information, and send information relating to the first error to a notification destination associated with the first error in a case where the first error has occurred in the electronic device.

### CROSS-REFERENCE TO RELATED APPLICATIONS

The present application claims priority under 35 U.S.C. § 119 to Japanese Patent Application No. 2020-166997, filed on Oct. 1, 2020, the entire contents of which are incorporated herein by reference.

### BACKGROUND OF THE INVENTION

### 1. Field of the Invention

The disclosures herein relate to a device management system, a device management method, and a recording medium.

### 2. Description of the Related Art

There are known systems that inform a user of information relating to an error that has occurred in an electronic device performing a predetermined process.

For example, in a technology described in Patent Document 1, if an error occurs, an image forming apparatus, performing jobs input from a plurality of information terminals, determines an information terminal to inform of information relating to the error, based on the distance between the image forming apparatus and each of the information terminals.

However, in the technology described in Patent Document 1, the error cannot be necessarily resolved by the user of the information terminal that the image forming apparatus notified of the information relating to the error. Therefore, in the related-art, if an error that cannot be resolved 4by the user occurs in an electronic device performing a predetermined process, it is difficult to send information relating to the error to a notification destination based on the error contents.

### RELATED-ART DOCUMENTS

### Patent Documents

Patent Document 1: Japanese Unexamined Patent Application Publication No. 2017-019162

### SUMMARY OF THE INVENTION

According to an embodiment of the present invention, a device management system includes a memory, and a processor coupled to the memory and configured to collect device information of an electronic device, determine whether a first error that is an error not resolvable by a user has occurred in the electronic device based on the device information, and send information relating to the first error to a notification destination associated with the first error in a case where the first error has occurred in the electronic device.

### BRIEF DESCRIPTION OF THE DRAWINGS

Other objects and further features of the present invention will be apparent from the following detailed description when read in conjunction with the accompanying drawings, in which:

FIG. 1 is a diagram illustrating the system configuration of a device management system according to an embodiment;

FIG. 2 is a diagram illustrating an example of the hardware configuration of a computer according to an embodiment;

FIG. 3 is a diagram illustrating an example of the hardware configuration of an image forming apparatus according to an embodiment;

FIG. 4 is a diagram illustrating an example of the functional configuration of the device management system according to a first embodiment;

FIG. 5A through 5D are tables illustrating examples of information managed by the device management system;

FIG. 6A through 6C are tables illustrating examples of information managed by the device management system;

FIG. 7 is a flowchart of a process performed by the device management system according to the first embodiment;

FIG. 8 is a flowchart of a process for obtaining a notification destination of an analyst according to the first embodiment;

FIG. 9 is a diagram illustrating the functional configuration of a device management system according to a second embodiment;

FIG. 10 is a table illustrating an example of inventory information according to the second embodiment; and

FIG. 11 is a flowchart of a determination process according to the second embodiment.

### DESCRIPTION OF THE EMBODIMENTS

An embodiment of the present invention provides a device management system in which, if an error that is not resolvable by a user occurs in an electronic device performing a predetermined process, information relating to the error can be sent to an appropriate notification destination determined based on the error contents.

In the following, embodiments of the present invention will be described with reference to the accompanying drawings.

<System Configuration>

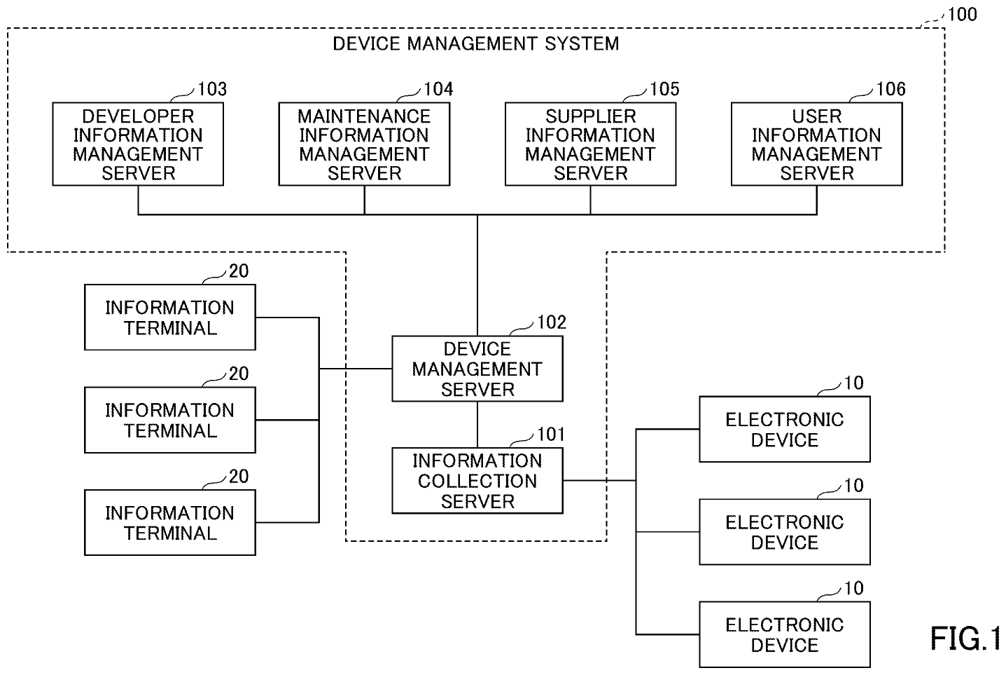

FIG. 1 is a diagram illustrating a system configuration of a device management system according to an embodiment. As an example, a device management system 100 includes an information collection server 101, a device management server 102, a developer information management server 103, a maintenance information management server 104, a supplier information management server 105, and a user information management server 106.

For example, the information collection server 101 is an information processing apparatus such as a computer, or a system including a plurality of information processing apparatuses. The information collection server 101 collects device information transmitted by one or more electronic devices 10 via a communication network.

The one or more electronic devices 10 are connected to a communication network such as the Internet, a local area network (LAN), or the like, and periodically transmit device information related to the electronic devices 10. Examples of the electronic devices 10 include image forming apparatuses such as multifunction peripherals (MFPs) each having functions such as a printer, a scanner, a copier, and a facsimile.

However, the electronic devices 10 are not limited to the image forming apparatuses, and may be any apparatuses that transmit predetermined device information to the information collection server 101. For example, the electronic devices 10 may each be an output apparatus such as a projector (PJ), an interactive white board (IWB, a white board with a function of an electronic blackboard capable of mutual communications), a digital signage, or the like. Further, the electronic devices 10 may each be an industrial machine, an imaging device, a sound collector, a medical device, a network home appliance, a vehicle (connected car), a communication apparatus, or an information processing apparatus. In the following, the electronic devices 10 are described as image forming apparatuses, as an example.

The device information transmitted by each of the electronic devices 10 includes history information indicating processes performed by each of the electronic devices 10, such as printing, copying, and scanning, and error information indicating the contents of an error that has occurred in each of the electronic devices 10. The error information includes, for example, a “device serial number”, “device location information”, an “error type”, an “error code”, and a “date and time of error occurrence”.

The information collection server 101 collects the device information transmitted by the one or more electronic devices 10, and stores the device information in a storage or the like, for management. From among the collected device information, if any device information of an electronic device 10 includes error information, the information collection server 101 sends the device information that includes the error information to the device management server 102.

The device management server (device management apparatus) 102 is an information processing apparatus such as a computer, or a system including a plurality of information processing apparatuses. The device management server 102 sends information relating to an error, which has occurred in the electronic device 10, to an appropriate notification destination based on the device information sent by the information collection server 101.

For example, if the error information included in the device information sent by the information collection server 101 indicates that the error is resolvable by the user of the electronic device 10, the device management server 102 sends information relating to the error to a notification destination associated with the user of the electronic device 10. Examples of the error that is resolvable by the user include minor errors such as a paper jam and out of paper. Examples of the notification destination associated with the user include an email address of the user (such as an email address of a company, a facility, an organization, or an individual) using the electronic device 10, and information (such as account information and a telephone number) used to send information to an information terminal 20 used by the user.

The device management server 102 can obtain the notification destination (such as an email address) associated with the user from the user information management server 106 that manages information related to users who use the electronic devices 10.

If the error information included in the device information sent by the information collection server 101 indicate that the error is not resolvable by the user of the electronic device 10, the device management server 102 obtains a notification destination of a person, a company, or the like capable of resolving the error, and sends information relating to the error, which has occurred in the electronic device 10, to the notification destination.

If the error information included in the device information sent by the information collection server 101 indicates that the error is not resolvable by the user and is related to a consumable item, the device management server 102 sends information relating to the error to a notification destination associated with a supplier of the consumable item. Examples of the error related to the consumable item include an error indicating that toner needs to be replaced. Further, examples of the notification destination associated with the supplier include an email address of the supplier that supplies consumables for the electronic device 10, and information (such as account information and a telephone number) used to send information to an information terminal 20 used by the supplier. Note that the notification destination associated with the supplier may be an email address of a manager or a management division responsible for management of consumables in an organization where the electronic device 10 is installed.

The device management server 102 can obtain the notification destination (such as an email address, a telephone number, or account information) associated with the supplier from the supplier information management server 105 that manages information related to suppliers that supply consumables for the electronic device 10.

If the error information included in the device information sent by the information collection server 101 indicates that the error is not resolvable by the user, but is resolvable by a maintenance technician, the device management server 102 sends information relating to the error to a notification destination associated with a maintenance technician responsible for maintaining the electronic device 10. Examples of errors that are resolvable by the maintenance technician include replacement, repair, and adjustment of units and parts. Further, contact information associated with the maintenance technician may be, for example, an email address of the maintenance technician responsible for maintaining the electronics 10, an email address of a company undertaking maintenance of the electronic device 10, or the like. Further, the contact information associated with the maintenance technician may be, for example, information (such as account information or a telephone number) used to send information to an information terminal 20 used by the maintenance technician.

The device management server 102 can obtain the notification destination (such as an email address, a telephone number, or account information) associated with the maintenance technician from the maintenance information management server 104 that manages information related to maintenance technicians responsible for maintaining the electronic device 10.

Further, if the error information included in the device information sent by the information collection server 101 indicates that the error is not resolvable by any of the user, the supplier, and the maintenance technician, the device management server 102 sends information relating to the error to a notification destination associated with an analyst who analyzes a failure. Examples of the analyst who analyzes a failure include developers who developed hardware and software of the electronic device 10.

The device management server 102 can obtain the notification destination (such as an email address, a telephone number, or account information) associated with the developer from the developer information management server 103 that manages information related to developers who developed hardware and software of the electronic device 10.

In this manner, if the error information included in the device information sent by the information collection server 101 indicates that the error is not resolvable by the user of the electronic device 10, the device management server 102 obtains a notification destination of a person, a company, or the like capable of resolving the error, and sends information relating to the error, which has occurred in the electronic device 10, to the notification destination.

Each of the developer information management server 103, the maintenance information management server 104, the supplier information management server 105, and the user information management server 106 is, for example, an information processing apparatus such as a computer, or a system including a plurality of information processing apparatuses.

One or more information terminals 20 are, for example, information processing apparatuses such as personal computers (PCs), smartphones, tablets, wearable terminals used by users, suppliers, maintenance technicians, and developers.

With the above-described configuration, if an error that is not resolvable by the user has occurred in the electronic device 10 performing a predetermined process, the device management system 100 determines an appropriate notification destination of a person, a company, or the like capable of resolving the error, and sends information relating to the error to the determined notification destination. Accordingly, the present embodiment can provide the device management system 100 in which, if an error that is not resolvable by the user has occurred in the electronic device 10 performing a predetermined process, information relating to the error can be sent to an appropriate notification destination determined based on the error contents.

The system configuration of the device management system 100 illustrated in FIG. 1 is merely an example. For example, the functions of the information collection server 101 may be included in the device management server 102. Further, at least some of the functions of the developer information management server 103, the maintenance information management server 104, the supplier information management server 105, and the user information management server 106 may be included in the device management server 102. Further, the functions of the developer information management server 103, the maintenance information management server 104, the supplier information management server 105, and the user information management server 106 may be implemented by an external cloud service or the like of the device management system 100.

<Hardware Configuration>

(Hardware Configuration of Computer)

The information collection server 101, the device management server 102, the developer information management server 103, the maintenance information management server 104, the supplier information management server 105, the user information management server 106, the information terminals 20, and the like are implemented by one or more computers.

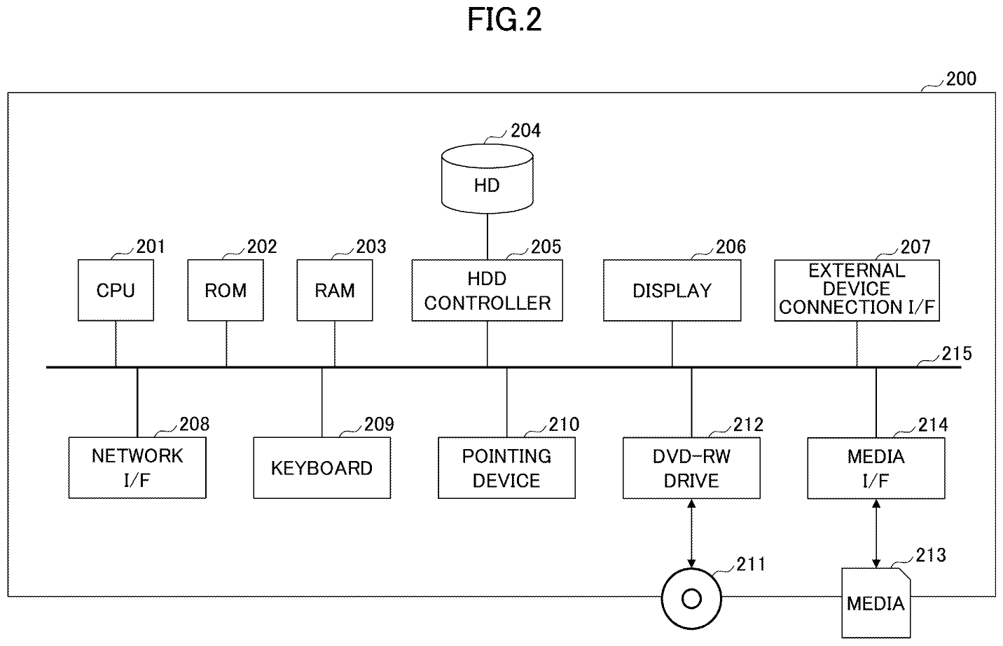

FIG. 2 is a diagram illustrating an example of the hardware configuration of a computer according to an embodiment. As illustrated in FIG. 2, a computer 200 includes a central processing unit (CPU) 201, a read-only memory (ROM) 202, a random access memory (RAM) 203, a hard disk (HD) 204, a hard disk drive (HDD) controller 205, a display 206, an external device connection interface (I/F) 207, a network I/F 208, a keyboard 209, a pointing device 210, a digital versatile disk rewritable (DVD-RW) drive 212, a media I/F 214, and a bus line 215.

The CPU 201 controls the entire operation of the computer 200. The ROM 202 stores, for example, a program such as an initial program loader (IPL) used to start the CPU 201. The RAM 203 is used as a work area for the CPU 201. The HD 204 stores various types of data such as programs. The HDD controller 205 controls reading and writing of various types of data from and to the HD 204 as controlled by the CPU 201.

The display 206 displays various types of information such as a cursor, menus, windows, characters, and images. Note that the display 206 may be provided outside the computer 200. The external device connection I/F 207 is an interface for connecting various types of external devices. Examples of the external devices include a universal serial bus (USB) memory and a printer. The network I/F 208 is an interface for data communication via the communication network.

The keyboard 209 is a type of an input device having a plurality of keys for inputting characters, numbers, and various types of instructions. The pointing device 210 is a type of an input device that selects or executes various types of instructions, selects an object to be processed, and moves the cursor. The keyboard 209 and the pointing device 210 may be provided outside the computer 200.

The DVD-RW drive 212 controls reading and writing of various types of data from and to a DVD-RW 211. The DVD-RW 211 is as an example of a removable recording medium. Note that the DVD-RW 211 is not limited to the DVD-RW, and may be a DVD-R. The media I/F 214 controls reading and writing (storage) of data from and to (into) a media 213 such as a flash memory. The bus line 215 includes an address bus, a data bus, and various types of control signals for electrically connecting the above-described elements.

(Hardware Configuration of Image Forming Apparatus)

As an example of a hardware configuration of the electronic device 10, a hardware configuration of an image forming apparatus (MFP) will be described.

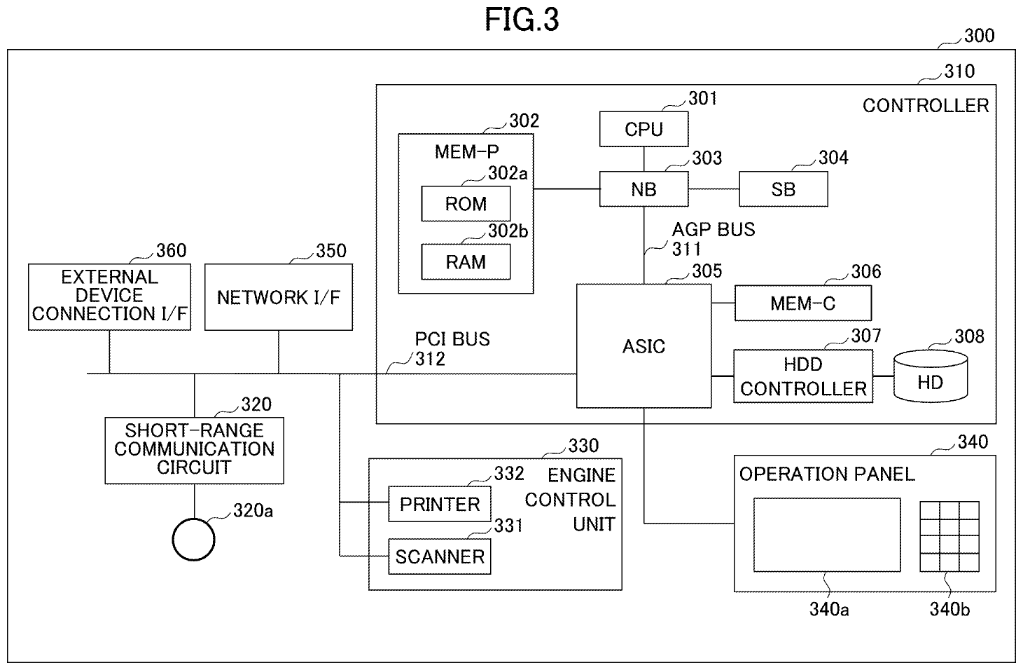

FIG. 3 is a diagram illustrating an example of the hardware configuration of an image forming apparatus according to an embodiment. As illustrated in FIG. 3, an image forming apparatus 300 includes a controller 310, a short-range communication circuit 320, an engine control unit 330, an operation panel 340, a network I/F 350, and an external device connection I/F 660.

The controller 310 includes a CPU 301, which is the main part of the computer, a system memory (MEM-P) 302, a northbridge (NB) 303, a southbridge (SB) 304, an application-specific integrated circuit (ASIC) 305, a local memory (MEM-C) 306, an HDD controller 307, and a HD 308. The NB 303 and the ASIC 305 are connected via an accelerated graphics port (AGP) bus 311.

The CPU 301 is a control unit that performs overall control of the image forming apparatus 300. The NB 303 is a bridge that connects the CPU 301 to the MEM-P 302, the SB 304, and the AGP bus 311, and includes a memory controller that controls reading/writing from/to the MEM-P 302, a peripheral component interconnect (PCI) master, and an AGP target.

The MEM-P 302 includes a ROM 302a and a RAM 302b. The ROM 302a is a memory that stores programs and data for implementing functions of the controller 310. The RAM 302b is a memory used for deployment of programs and data, and for image rendering performed by a printer. A program stored in the RAM 302b may be recorded and provided in a computer-readable recording medium such as a CD-ROM, a CD-R or a DVD in an installable format or an executable format file.

The SB 304 is a bridge that connects the NB 303 to PCI devices and peripheral devices. The ASIC 305 is an integrated circuit (IC) for use in image processing and having hardware elements for image processing. The ASIC 305 is connected to the AGP bus 311, a PCI bus 312, the HDD controller 307, and the MEM-C 306. The ASIC 305 includes a PCI target and an AGP master, an arbiter (ARB) that forms the core of the ASIC 305, a memory controller that controls the MEM-C 306, a plurality of direct memory access controllers (DMAC) that rotate image data using hardware logic, and a PCI unit that transfers data between a scanner 331 and a printer 332 via the PCI bus 312.

The MEM-C 306 is a local memory used as a copy image buffer and a code buffer. The HD 308 is storage that stores image data, font data used at the time of printing, and forms. The HD 308 may store programs such as an operating system (OS), applications, and device drivers, and various type of data. The HDD controller 307 controls reading and writing of data from and to the HD 308, as controlled by the CPU 301. The AGP BUS 311 is a bus interface for a graphics accelerator card introduced to accelerate graphics processes. The AGP BUS 311 directly accesses the MEM-P 302 with a high throughput, thereby accelerating processes related to the graphics accelerator card.

The short-range communication circuit 320 uses a short-range wireless communication unit 320a to perform short-range wireless communication. The engine control unit 330 includes a scanner 331 and a printer 332. The scanner 331 is a reading device that reads a document. The printer 332 is a printing device that prints print data on a printing medium. The scanner 331 or the printer 332 includes an image processing section such as error diffusion or gamma correction.

The operation panel 340 includes a panel display 340a such as a touch panel, and also includes operation buttons 340b. The panel display 340a displays current setting values and a selection screen, and receives an input from an operator. The operation buttons 340b include a numeric keypad that receives setting values related to image forming conditions such as density setting conditions, and also includes a start key that receives an instruction to start copying. The controller 310 performs overall control of the image forming apparatus 300, and controls, for example, image rendering, communication, and inputs from the operation panel 340.

The network I/F 350 is an interface for data communication via the communication network. The external device connection I/F 360 is, for example, an interface such as a USB for connecting an external device to the image forming apparatus 300. The short-range communication circuit 320, the network I/F 350, and the external device connection I/F 360 are electrically coupled to the ASIC 305 via the PCI bus 312, for example.

Note that the electronic device 10 may have any hardware configuration as long as the electronic device 10 includes the hardware configuration of the computer and the network I/F 350.

### First Embodiment

<Functional Configuration>

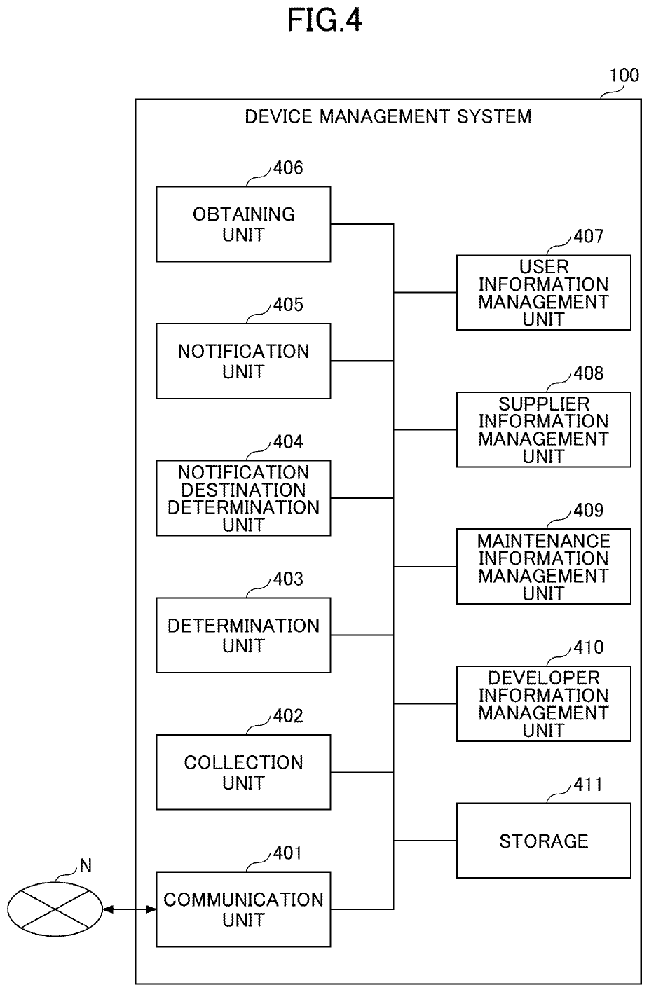

Next, a functional configuration of the device management system 100 according to a first embodiment will be described. FIG. 4 is a diagram illustrating an example of the functional configuration of the device management system according to the first embodiment. The device management system 100 implements a functional configuration as illustrated in FIG. 4 by executing programs on one or more computers 200. For example, the device management system 100 includes a communication unit 401, a collection unit 402, a determination unit 403, a notification destination determination unit 404, a notification unit 405, an obtaining unit 406, a user information management unit 407, a supplier information management unit 408, a maintenance information management unit 409, a developer information management unit 410, and a storage 411. One or more of the above-described functional configurations may be implemented by hardware.

The communication unit 401 uses the network I/F 208 to connect the device management system 100 to a communication network N such as the Internet or a local area network (LAN), and communicates with the one or more electronic devices 10 and the one or more information terminals 20.

The collection unit 402 collects device information of the one or more electronic devices 10. For example, the collection unit 402 receives device information, transmitted from the one or more electronic devices 10, via the communication unit 401, and stores the received device information in the storage 411.

If error information is included in device information of an electronic device 10, from among the device information of the one or more electronic devices 10 collected by the collection unit 402 (that is, if an error occurs in an electronic device 10), the determination unit 403 determines whether the error that has occurred in the electronic device 10 is a first error that is not resolvable by the user.

In addition, if error information is included in device information of an electronic device 10, from among the device information of the one or more electronic devices 10 collected by the collection unit 402, it is preferable for the determination unit 403 to also determine whether the error that has occurred in the electronic device 10 is a second error that is resolvable by the user.

As used herein, the “error information” included in device information of an electronic device 10 includes a “device serial number”, “device location information”, an “error type”, an “error code”, and a “date and time of error occurrence”. Further, the device information or the error information includes log information for analyzing the error.

The “device serial number” is, for example, identification information for identifying the electronic device 10, and may be information such as a device ID or a device name. The device location information is, for example, information for identifying a region where the electronic device 10 is installed, and may include information such as coordinates information, an address, an office name, or a floor number. The “error type” is information indicating a group to which the error that has occurred belongs. Errors are classified into multiple groups according to failure locations (such as hardware and software), functions (such as copying, printing, and scanning), importance levels, and difficulty levels. The “error code” is identification information for identifying the error contents, and may be an error ID, an error name, or the like. The “date and time of error occurrence” is information indicating the date and time when the error occurred.

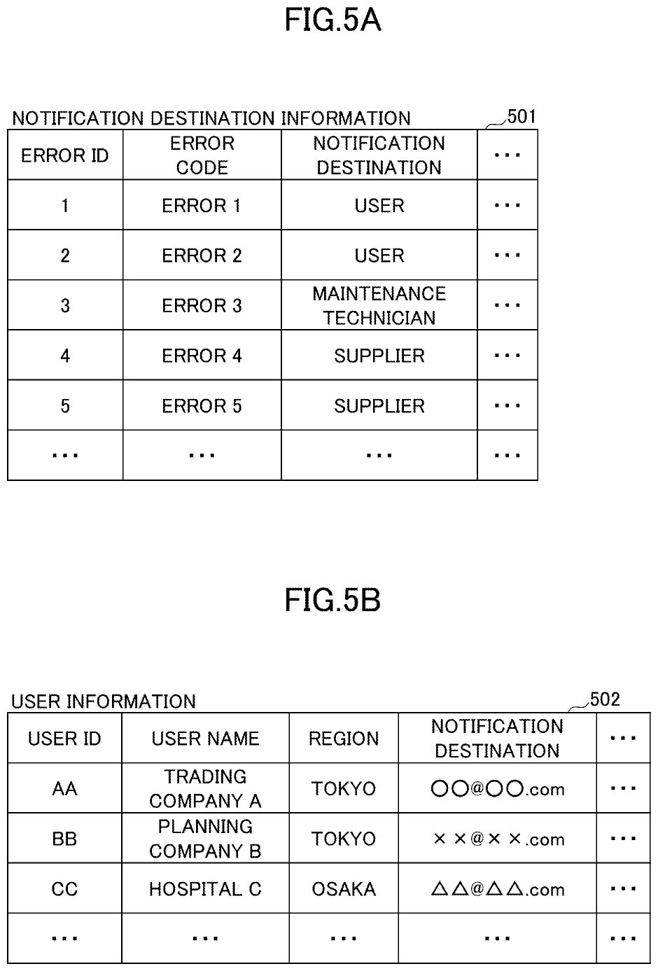

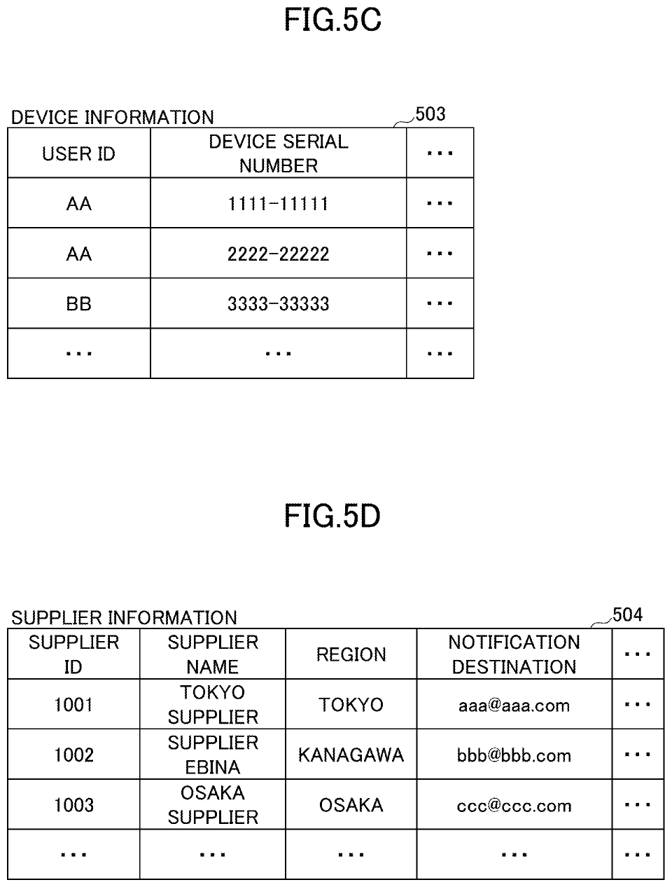

Further, the device management system 100 stores notification destination information 501 as illustrated in FIG. 5A in the storage 411 in advance. In the example of FIG. 5A, the notification destination information 501 stores a plurality of error codes (or error IDs) and information of notification destinations (such as a “user”, a “maintenance technician”, and a “supplier”) associated with the error codes.

For example, the determination unit 403 determines that the second error that is resolvable by the user has occurred in the electronic device 10 if a notification destination associated with an error code included in the error information is the “user” by referring to the notification destination information 501 as illustrated in FIG. 5A. Further, the determination unit 403 determines that the first error that is not resolvable by the user has occurred in the electronic device 10 if a notification destination associated with an error code included in the error information is not the “user” by referring to the notification destination information 501.

As another example, the device management system 100 may store, in the notification destination information 501, a plurality of error types and information of notification destinations associated with the error types. In this case, the determination unit 403 can determine whether the first error that is not resolvable by the user has occurred in the electronic device 10 by referring to both the “error type” included in the error information and the notification destination information 501.

Accordingly, the determination unit 403 determines whether the first error that is not resolvable by the user has occurred in the electronic device 10 based on the device information of the electronic device 10, collected by the collection unit 402. In the notification destination information 501 illustrated in FIG. 5A, errors associated with “error 3”, “error 4”, and “error 5” are examples of the first error that is not resolvable by the user.

Further, the determination unit 403 determines whether the second error that is not resolvable by the user has occurred in the electronic device 10 based on the device information of the electronic device 10, collected by the collection unit 402. In the notification destination information 501 illustrated in FIG. 5A, errors associated with “error 1” and “error 2” are examples of the second error that is resolvable by the user.

The notification destination determination unit 404 identifies a notification destination to which to send information relating to the error that has occurred in the electronic device 10.

For example, if the second error that is resolvable by the user has occurred in the electronic device 10, the notification destination determination unit 404 uses information managed by the user information management unit 407 to identify a notification destination to which to send information relating to the second error.

The user information management unit 407 stores user information 502 as illustrated in FIG. 5B and device information 503 as illustrated in FIG. 5C in the storage 411 for management. The notification destination determination unit 404 uses the “device serial number” included in the error information to identify a user ID by referring to the device information 503. Then, the notification destination determination unit 404 uses the identified user ID to obtain a notification destination (such as an email address) by referring to the user information 502.

If the first error that is not resolvable by the user has occurred in the electronic device 10, the notification destination determination unit 404 determines an appropriate notification destination to which to send information relating to the first error.

For example, if the first error that has occurred in the electronic device 10 is related to a consumable item, the notification destination determination unit 404 uses information managed by the supplier information management unit 408 to identify a notification destination to which to send information relating to the first error.

The supplier information management unit 408 stores supplier information 504 as illustrated in FIG. 5D in the storage 411 for management. The notification destination determination unit 404 uses the “device location information” included in the error information to identify a region where the electronic device 10 is installed. Then, the notification destination determination unit 404 uses the identified region to obtain a notification destination (such as an email address) by referring to the supplier information 504.

If the first error is not related to a consumable item, and is resolvable by a maintenance technician responsible for maintaining the electronic device 10, the notification destination determination unit 404 uses information managed by the maintenance information management unit 409 to identify a notification destination to which to send information relating to the first error.

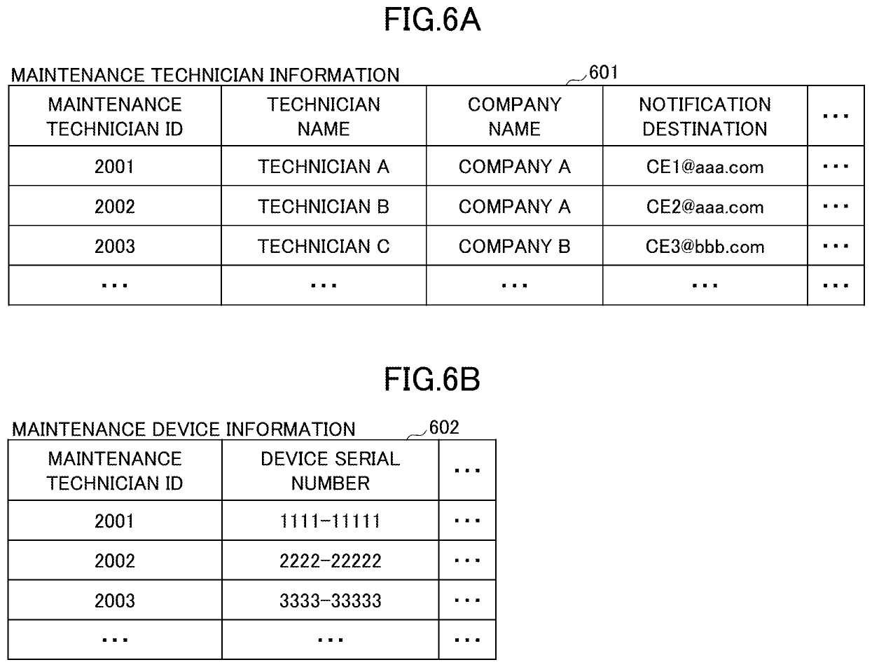

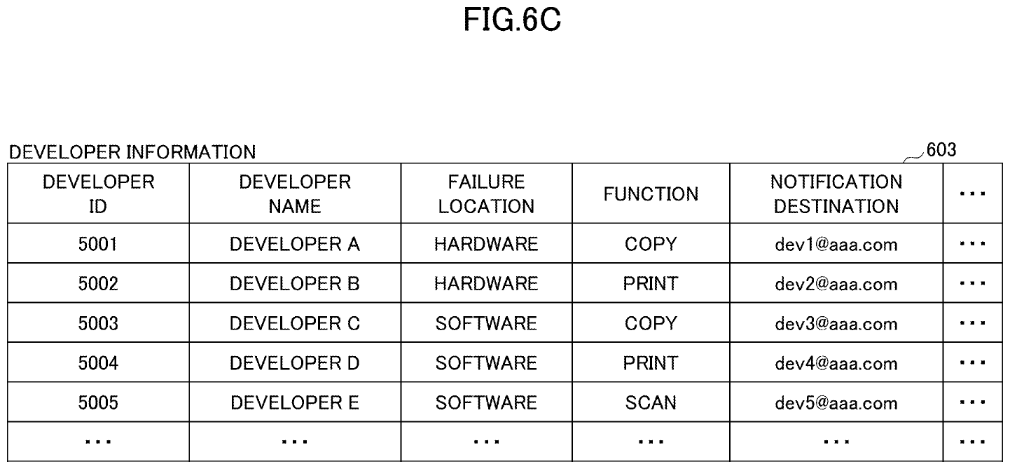

The maintenance information management unit 409 stores maintenance technician information 601 as illustrated in FIG. 6A and maintenance device information 602 as illustrated in FIG. 6B in the storage 411 for management. The notification destination determination unit 404 uses the “device serial number” included in the error information to identify a maintenance technician ID by referring to the maintenance device information 602. Then, the notification destination determination unit 404 uses the identified maintenance technician ID to obtain a notification destination (such as an email address) by referring to the maintenance technician information 601.

If the first error is not related to a consumable item, and is not resolvable by a maintenance technician responsible for maintaining the electronic device 10, the notification destination determination unit 404 identifies a notification destination of an analyst who analyzes a failure of the electronic device 10. In this case, the notification destination determination unit 404 uses the obtaining unit 406, which will be described below, to obtain a notification destination (such as an email address) of the analyst.

If the first error that is not resolvable by the user has occurred in the electronic device 10, the notification unit 405 sends information relating to the first error to a notification destination associated with the first error, which is determined by the notification destination determination unit 404. If the second error that is resolvable by the user has occurred in the electronic device 10, the notification unit 405 sends information relating to the second error to a notification destination associated with the user of the electronic device 10.

If the error that has occurred in the electronic device 10 is not related to a consumable item, and is not resolvable by a maintenance technician responsible for maintaining the electronic device 10, the obtaining unit 406 obtains a notification destination associated with an analyst who analyzes a failure of the electronic device 10. For example, the obtaining unit 406 analyses the log information included in the device information, identifies a failure location and a function where the error has occurred in the electronic device 10, and obtains a notification destination (such as an email address) of a developer who developed the error location (hardware or software) and the function.

The user information management unit 407 stores the user information 502 as illustrated in FIG. 5B and the device information 503 as illustrated in FIG. 5C in the storage 411 for management. For example, the user information management unit 407 may be implemented by the user information management server 106 illustrated in FIG. 1, or may be implemented by a program executed by the device management server 102.

The supplier information management unit 408 stores the supplier information 504 as illustrated in FIG. 5D in the storage 411 for management. For example, the supplier information management unit 408 may be implemented by the supplier information management server 105 illustrated in FIG. 1, or may be implemented by a program executed by the device management server 102.

The maintenance information management unit 409 stores the maintenance technician information 601 as illustrated in FIG. 6A and the maintenance device information 602 as illustrated in FIG. 6B in the storage 411 for management. For example, the maintenance information management unit 409 may be implemented by the maintenance information management server 104 illustrated in FIG. 1, or may be implemented by a program executed by the device management server 102.

The developer information management unit 410 stores developer information 603 as illustrated in FIG. 6C in the storage 411 for management. For example, the developer information management unit 410 may be implemented by the developer information management server 103 illustrated in FIG. 1, or may be implemented by a program executed by the device management server 102.

In the example of FIG. 6C, the developer information 603 includes information, as items, such as a “developer ID”, a “developer name”, an “error location”, a “function”, and a “notification destination”. The “developer ID” is identification information for identifying a developer. The “developer name” is information indicating the name or the like of the developer. The “failure location” is information indicating that an error is related to hardware or related to software. The “function” is information indicating a function where the error occurred. The “notification destination” is information indicating an email address or the like of the developer to which to send information relating to the error.

The storage 411 is implemented by storage devices such as the HD 204 and the HDD controller 205 of the computer 200. The storage 411 may be implemented by a combination of storage devices of a plurality of computers 200, or may be implemented by a single storage server.

The functional configuration of the device management system 100 illustrated in FIG. 4 may be implemented by a plurality of servers as illustrated in FIG. 1, or may be implemented by the single device management server (device management apparatus) 102.

<Process Flow>

Next, a device management method according to the first embodiment will be described.

(Process Performed by Device Management System)

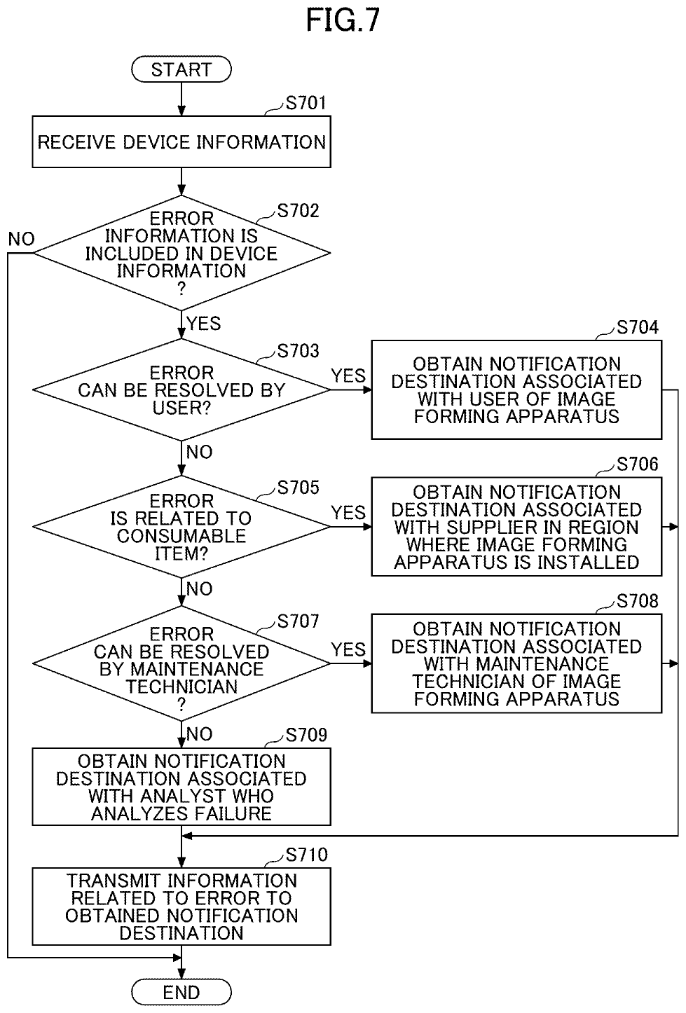

FIG. 7 is a flowchart of a process performed by the device management system according to the first embodiment. The process illustrated in FIG. 7 is an example of a process performed by the device management system 100 having the functional configuration illustrated in FIG. 4 when device information is received from the image forming apparatus 300 (an example of the electronic device 10).

In response to the communication unit 401 of the device management system 100 receiving device information from the image forming apparatus 300 in step S701, the device management system 100 performs step S702 and the subsequent steps.

In step S702, the collection unit 402 collects the device information received by the communication unit 401, and determines whether error information is included in the collected device information. If error information is not included in the device information, the collection unit 402 ends the process illustrated in FIG. 7. Conversely, if error information is included in the device information, the collection unit 402 causes the process to proceed to step S703.

In step S703, the determination unit 403 determines whether an error that has occurred in the image forming apparatus 300 is the first error that is not resolvable by the user or the second error that is resolvable by the user, based on the device information collected by the collection unit 402. For example, the determination unit 403 obtains the error code from the error information. Then, the determination unit 40 determines whether a notification destination associated with the obtained error code is the “user” by referring to the notification destination information 501 as illustrated in FIG. 5A. If the notification destination associated with the obtained error code is not the “user”, the determination unit 403 determines that the first error that is not resolvable by the user has occurred in the image forming apparatus 300. Conversely, if the notification destination associated with the obtained error code is the “user”, the determination unit 403 determines that the second error that is resolvable by the user has occurred in the image forming apparatus 300.

If the error that has occurred in the image forming apparatus 300 is the second error that is resolvable by the user, the determination unit 403 causes the process to proceed to step S704. Conversely, if the first error that is not resolvable by the user has occurred in the image forming apparatus 300, the determination unit 403 causes the process to proceed to step S705.

In step S704, the notification destination determination unit 404 obtains a notification destination associated with the user who uses the image forming apparatus 300 from which the device information is transmitted. For example, the notification destination determination unit 404 obtains the device serial number from the error information, and obtains a user ID associated with the obtained device serial number by referring to the device information 503 as illustrated in FIG. 5C. Further, the notification destination determination unit 404 obtains a notification destination (such as an email address of the user) associated with the obtained user ID by referring to the user information 502 as illustrated in FIG. 5B.

Conversely, in step S705, the notification destination determination unit 404 determines whether the error that has occurred in the image forming apparatus 300 is related to a consumable item. For example, if the error information of the collected device information indicates that the error is related to a consumable item (that is, if the error information includes “error 4” or “error 5”), the notification destination determination unit 404 determines that the error that has occurred in the image forming apparatus 300 is related to a consumable item.

If the error that has occurred in the image forming apparatus 300 is related to a consumable item, the notification destination determination unit 404 causes the process to proceed to step S706. Conversely, if the error that has occurred in the image forming apparatus 300 is not related to a consumable item, the notification destination determination unit 404 causes the process to proceed to step S707.

In step S706, the notification destination determination unit 404 obtains a notification destination associated with a supplier in a region where the image forming apparatus 300 is installed. For example, the notification destination determination unit 404 obtains the device location information from the error information, and identifies a region where the image forming apparatus 300 is installed based on the device location information. Further, the notification destination determination unit 404 obtains a notification destination (such as an email address of a supplier) associated with the identified region by referring to the supplier information 504 as illustrated in FIG. FIG. 5D.

In step S707, the notification destination determination unit 404 determines whether the error that has occurred in the image forming apparatus 300 is resolvable by a maintenance technician. For example, if the error information of the collected device information indicates that the error is resolvable by a maintenance technician (that is, if the error information includes “error 3”), the notification destination determination unit 404 determines that the error that has occurred in the image forming apparatus 300 is resolvable by a maintenance technician.

If the error that has occurred in the image forming apparatus 300 is resolvable by a maintenance technician, the notification destination determination unit 404 causes the process to proceed to step S708. Conversely, if the error that has occurred in the image forming apparatus 300 is not resolvable by a maintenance technician, the notification destination determination unit 404 causes the process to proceed to step S709.

In step S708, the notification destination determination unit 404 obtains a notification destination associated with a maintenance technician responsible for maintaining the image forming apparatus 300 in which the error has occurred. For example, the notification destination determination unit 404 obtains the device serial number from the error information, and obtains a maintenance technician ID associated with the obtained device serial number by referring to the maintenance device information 602 as illustrated in FIG. 6B. Further, the notification destination determination unit 404 obtains a notification destination (such as an email address of a maintenance technician) associated with the obtained maintenance technician ID by referring to the maintenance technician information 601 as illustrated in FIG. 6A.

Conversely, in step S709, the notification destination determination unit 404 uses the obtaining unit 406 to obtain a notification destination associated with an analyst who can analyze a failure (error) that has occurred in the image forming apparatus 300.

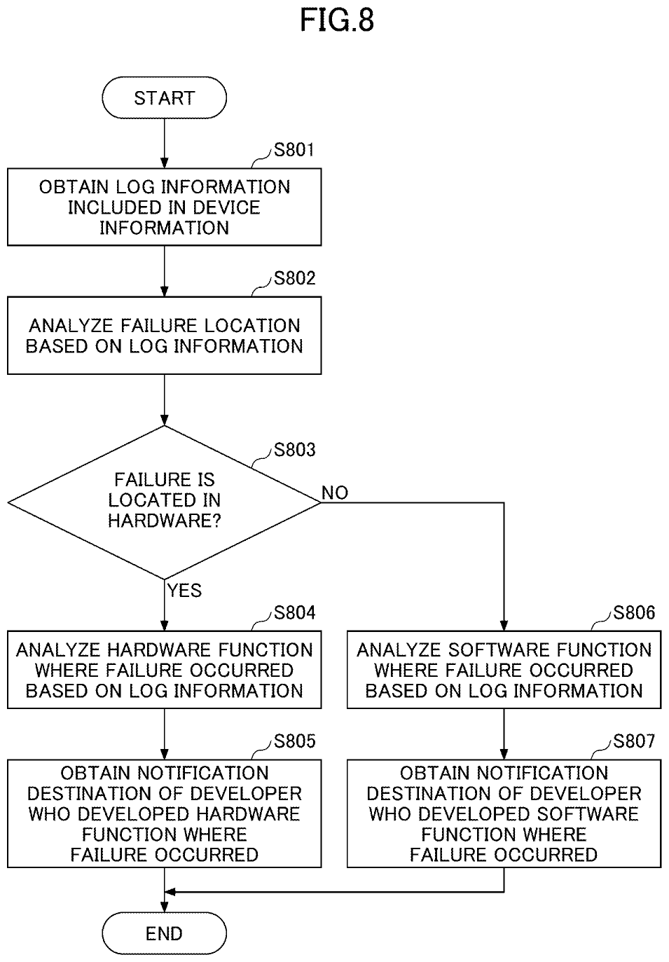

FIG. 8 is a flowchart of a process for obtaining a notification destination of an analyst according to the first embodiment. The process illustrated in FIG. 8 is an example of a process for obtaining a notification destination of an analyst, which is performed by the obtaining unit 406 in response to a request from the notification destination determination unit 404 in step S709 of FIG. 7.

In step S801, the obtaining unit 406 obtains the log information included in the device information. The log information is more detailed information relating to the error, that has occurred in image forming apparatus 300, than the error information. For example, the log information includes information relating to hardware (such as a unit, a component, or a function) in which the error has occurred, information relating to software (such as a function or a module) in which the error has occurred, information indicating the state of a memory at the time of error occurrence, or the like.

In step S802, the obtaining unit 406 analyzes whether the failure (error) that has occurred in the image forming apparatus 300 is located in hardware or software based on the log information. In step S803, if the failure is located in hardware, the obtaining unit 406 causes the process to proceed to step S804. Conversely, if the failure is not located in hardware (that is, the failure is located in software), the obtaining unit 406 causes the process to proceed to step S806.

In step S804, the obtaining unit 406 analyzes a hardware function where the failure occurred based on the log information. In step S805, the obtaining unit 406 obtains a notification destination (such as an email address of a developer) associated with the hardware function where the failure occurred by referring to the developer information 603 as illustrated in FIG. 6C.

Conversely, if the obtaining unit 406 causes the process to proceed to step S806 from step S803, the obtaining unit 406 analyzes a software function where the failure occurred. Further, in step S807, the obtaining unit 406 obtains a notification destination (such as an email address of a developer) associated with the software function where the failure occurred by referring to the developer information 603 as illustrated in FIG. 6C.

With the above-described process, the obtaining unit 406 obtains a notification destination of a developer who developed the image forming apparatus 300 if an error that is not resolvable by any of the user, the supplier, the maintenance technician, and the like has occurred. Further, with the above-described process, the obtaining unit 406 can select, from among developers who developed the image forming apparatus 300, a developer who is familiar with a failure location and a function where a failure (error) occurred, as an analyst who analyzes the failure (error).

Referring back to FIG. 7, the description of the process performed by the device management system will continue.

In step S710, the notification unit 405 transmits information relating to the error to the notification destination (such as an email address) obtained in step S703 through S708.

With the above-described process, if an error that is not resolvable by the user occurs in the image forming apparatus 300, the device management system 100 can transmit information relating to the error to an appropriate notification destination (of a person, a company, or the like capable of resolving the error).

The process performed by the device management system illustrated in FIG. 7 is merely an example. For example, in the process illustrated in FIG. 7, the determination unit 403 uses the notification destination information 501 to determine whether the error that has occurred in the electronic device 10 is the first error that is not resolvable by the user. However, the present invention is not limited thereto, and the determination unit 403 may determine whether the error that has occurred in the electronic device 10 is the first error that is not resolvable by the user by analyzing the log information included in the device information.

Similarly, the determination unit 403 may determine whether the error that has occurred in the electronic device 10 is an error related to a consumable item or an error that is resolvable by a maintenance technician by analyzing the log information included in the device information.

Accordingly, in the present embodiment, even if an error that is not resolvable by the user has occurred in the electronic device 10, the device management system 100 can easily notify an appropriate notification destination to resolve the error.

### Second Embodiment

In the first embodiment, the determination unit 403 uses device information collected by the collection unit 402 and the notification destination information 501 as illustrated in FIG. 5A to determine whether an error that has occurred in the image forming apparatus 300 is the second error that is resolvable by the user. However, with this method, even if consumables are in stock, information relating to the error is sent to a supplier. Therefore, the burden of the supplier may increase.

In view of the above, in the second embodiment, the determination unit 403 further uses inventory information of consumables to determine whether an error that has occurred in the image forming apparatus 300 is the second error that is resolvable by the user.

<Functional Configuration>

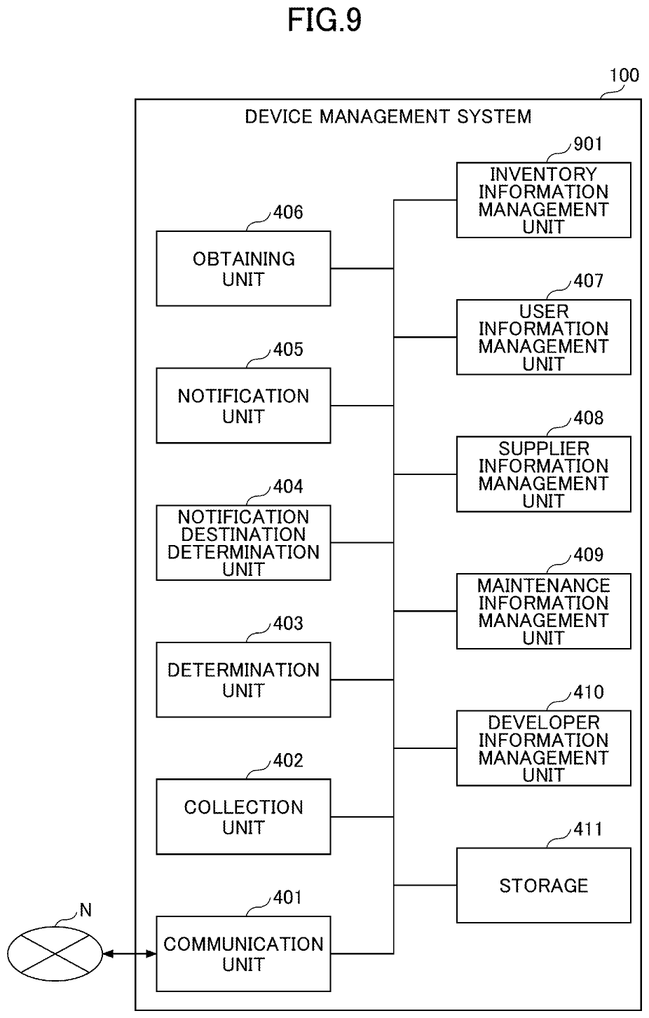

FIG. 9 is a diagram illustrating a functional configuration of a device management system according to a second embodiment. As illustrated in FIG. 9, a device management system 100 according to the second embodiment includes an inventory information management unit 901 in addition to the functional units of the device management system 100 described with reference to FIG. 4.

The inventory information management unit 901 is implemented by a program executed on the computer 200, and stores inventory information 1000 in the storage 411 or the like, for management.

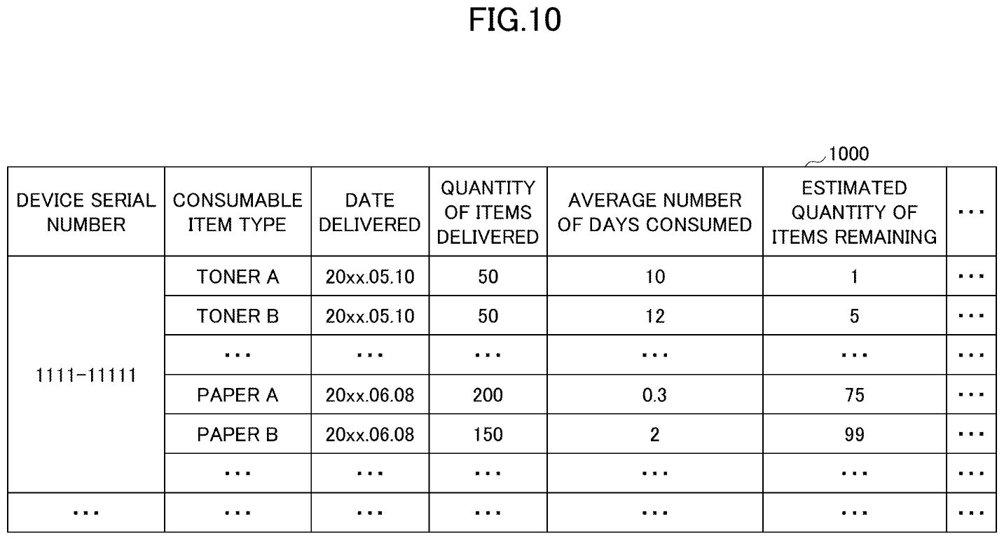

FIG. 10 is a table illustrating an example of inventory information according to the second embodiment. In the example of FIG. 10, the inventory information 1000 stores information such as a “device serial number” a “consumable item type”, a “date delivered”, the “quantity of items delivered”, the “average number of days consumed”, and the “estimated quantity of items remaining”. The above-described information may be provided by a supplier, or may be provided by a manager (or a management division) responsible for management of consumables at a site where the image forming apparatus 300 is installed.

In the example of FIG. 10, the above-described information is managed for each image forming apparatus 300. However, the present invention is not limited thereto, and the above-described information may be managed for each site where an image forming apparatus 300 is installed.

<Process Flow>

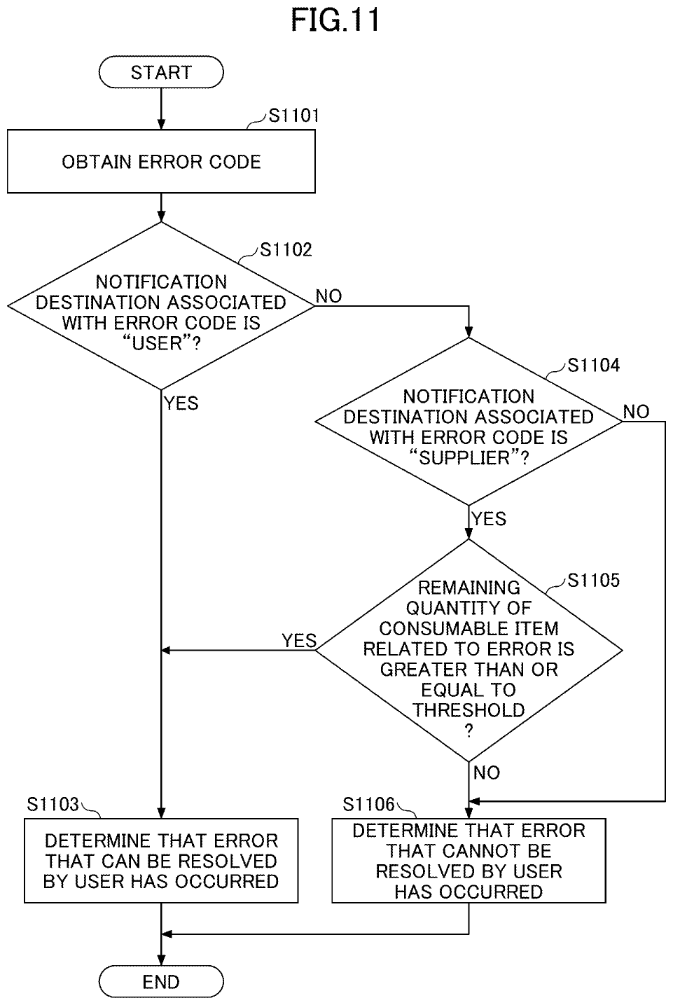

FIG. 11 is a flowchart of a determination process according to the second embodiment. The determination process illustrated in FIG. 11 is another example of a determination process performed by the determination unit 403 in step S703 of FIG. 7. Processes other than step S703 are similar to those in the first embodiment.

In step S1101, the determination unit 403 obtains the error code from the error information included in the device information collected by the collection unit 402.

In step S1102, the determination unit 403 determines whether a notification destination associated with the obtained error code is the “user” by referring to the notification destination information 501 as illustrated in FIG. 5A. If a notification destination associated with the obtained error code is the “user”, the determination unit 403 causes the process to proceed to step S1103. If a notification destination associated with the obtained error code is not the “user”, the determination unit 403 causes the process to proceed to step S1104.

In step S1103, the determination unit 403 determines that the second error that is resolvable by the user has occurred in the image forming apparatus 300.

Conversely in step S1104, the determination unit 403 determines whether a notification destination associated with the obtained error code is the “supplier” by referring to the notification destination information 501 as illustrated in FIG. 5A. If a notification destination associated with the obtained error code is the “supplier”, the determination unit 403 causes the process to proceed to step S1105. If a notification destination associated with the obtained error code is not the “supplier”, the determination unit 403 causes the process to proceed to step S1106.

In step S1105, the determination unit 403 determines whether the remaining quantity of a consumable item related to the error is greater than or equal to a threshold by referring to the inventory information 1000 as illustrated in FIG. 10. If the remaining quantity of a consumable item related to the error is greater than or equal to the threshold, the determination unit 403 causes the process to proceed to step S1103. Conversely, if the remaining quantity of a consumable item related to the error is less than the threshold, the determination unit 403 causes the process to proceed to step S1106.

Accordingly, with the above-described process, if an error related to a consumable item occurs in the image forming apparatus 300, the device management system 100 can send information relating to the error to the user instead of the supplier if the consumable item is in stock.

Further, for example, for consumable such as toner and paper of the image forming apparatus 300, the user can replenish such consumables. Therefore, according to the second embodiment, even if an error that is not resolvable by the user occurs in the electronic device 10 performing a predetermined process, information relating to the error can be sent to an appropriate notification destination.

As described above, the above-described embodiments can provide the device management system 100 in which, if an error that is not resolvable by the user occurs in the electronic device 10 performing a predetermined process, information relating to the error can be sent to an appropriate notification destination determined based on the error contents. Accordingly, even if an error that is not resolvable by the user occurs in the electronic device 10, the error can be sent to an appropriate notification destination and can be easily resolved.

<Supplementary Description>

The functions of the embodiments described above may be implemented by one or more processing circuits. As used herein, the “processing circuit” includes a processor programmed to cause software to execute the functions, such as a processor implemented by electronic circuitry, and an application-specific integrated circuit (ASIC), a digital signal processor (DSP), a field-programmable gate array (FPGA), and a circuit module designed to execute the above-described functions.

Further, a group of apparatuses described in the embodiments is merely one group of apparatuses in a plurality of computing environments. In a specific embodiment, the device management server 102 includes a plurality of computing devices such as server clusters. The plurality of computing devices are configured to communicate with each other via a commutation link such as a network or a shared memory, and perform the processes described herein. Similarly, the other servers included in device management system 100 can include a plurality of computing devices that are configured to communicate with each other.

Further, the device management system 100 may be configured to share various combinations of the steps described in FIG. 7, FIG. 8, and FIG. 11. For example, a process performed by a predetermined unit may be performed by the device management server 102. Similarly, the functions of a predetermined unit may be implemented by the information collection server 101. Further, the constituent elements of the device management system 100 may be integrated into one server apparatus or may be distributed over several apparatuses.

Further, the present invention is not limited to these embodiments, and various variations and modifications may be made without departing from the scope of the present invention.

What is claimed is:

1. A device management system comprising:
a memory; and
a processor coupled to the memory and configured to
collect device information of an electronic device,
determine whether a first error that is an error not resolvable by a user has occurred in the electronic device based on the device information, and
send information relating to the first error to a notification destination associated with the first error in a case where the first error has occurred in the electronic device.

2. The device management system according to claim 1, wherein the processor is configured to determine whether a second error that is an error resolvable by the user has occurred in the electronic device based on the device information, and
send information relating to the second error to a notification destination associated with the user in a case where the second error has occurred in the electronic device.

3. The device management system according to claim 1, wherein the processor is configured to send information relating to the first error to a notification destination associated with a supplier that supplies a consumable item, in a case where the first error has occurred in the electronic device and where the device information includes error information indicating that the first error is related to the consumable item.

4. The device management system according to claim 1, wherein the processor is configured to manage inventory information of a consumable item of the electronic device, and
determine that a second error that is an error resolvable by the user has occurred in the electronic device, in a case where the device information includes error information indicating that the second error is related to the consumable item and where the consumable item is in stock.

5. The device management system according to claim 1, wherein the processor is configured to send information relating to the first error to a notification destination associated with a maintenance technician responsible for maintaining the electronic device, in a case where the first error has occurred in the electronic device and where the device information includes error information indicating that the first error is resolvable by the maintenance technician.

6. The device management system according to claim 1, wherein the processor is configured to send information relating to the first error to a notification destination associated with an analyst who analyzes a failure of the electronic device, in a case where the first error has occurred in the electronic device and where the device information includes error information indicating that the first error is not related to a consumable item and is not resolvable by a maintenance technician responsible for maintaining the electronic device.

7. The device management system according to claim 6, wherein the device information includes log information relating to the first error, and
wherein the processor is configured to obtain, based on the log information, the notification destination associated with the analyst to which to send the information relating to the first error.

8. A device management method performed by a computer, the method comprising:
collecting device information of an electronic device,
determining whether a first error that is an error not resolvable by a user has occurred in the electronic device based on the device information, and
sending information relating to the first error to a notification destination associated with the first error in a case where the first error has occurred in the electronic device.

9. A non-transitory recording medium storing a program for causing a computer to execute a process comprising:
collecting device information of an electronic device,
determining whether a first error that is an error not resolvable by a user has occurred in the electronic device based on the device information, and
sending information relating to the first error to a notification destination associated with the first error in a case where the first error has occurred in the electronic device.
